(19) United States
(12) Patent Application Publication
(10) Pub. No.: US 2024/0199073 A1
(43) Pub. Date: Jun. 20, 2024

(54) ELECTRONIC CONTROL DEVICE AND IN-VEHICLE SYSTEM

(71) Applicant: Hitachi Astemo, Ltd., Hitachinaka-shi, Ibaraki (JP)

(72) Inventors: Hiroki MAEHAMA, Ibaraki (JP); Hiroaki ITO, Ibaraki (JP); Takeshi YAMADA, Ibaraki (JP); Koji MAEDA, Ibaraki (JP); Kazuyoshi SERIZAWA, Ibaraki (JP)

(73) Assignee: Hitachi Astemo, Ltd., Hitachinaka-shi, Ibaraki (JP)

(21) Appl. No.: 18/555,718

(22) PCT Filed: Feb. 4, 2022
(86) PCT No.: PCT/JP2022/004529

§ 371 Date: Oct. 16, 2023

(30) Foreign Application Priority Data
Jul. 5, 2021 (JP) 2021-111229

(51) Int. Cl. B60W 60/00; B60W 50/04

(52) U.S. Cl. CPC B60W 60/001; B60W 50/04; B60W 2530/00; B60W 2554/00

(57) ABSTRACT

An electronic control device that executes arithmetic processing for controlling an operation of a vehicle includes: a determination unit that is connected to one or a plurality of electronic devices that recognize an external environment on the basis of information of a sensor provided in the vehicle and determines an operation of the vehicle on the basis of external recognition information transmitted from the electronic devices; and a functional boundary change determination unit that determines changes in functions of the electronic control device and the electronic devices if it is determined that a processing load of the electronic control device is high.

### CROSS-REFERENCE TO RELATED APPLICATION

This application claims priority to Japanese Patent Application No. 2021-111229 filed on Jul. 5, 2021, the contents of which are incorporated herein by reference.

### TECHNICAL FIELD

The present invention relates to an electronic control device mounted on a vehicle.

### BACKGROUND ART

A vehicle is equipped with many electronic control devices such as an electronic control device that recognizes a target such as a vehicle or a pedestrian on the basis of information acquired by an external recognition sensor, electronic control device that integrates recognition results of targets and performs an arithmetic operation for automatic driving and driving assistance, and an electronic control device that controls an engine and an actuator. Although functions may be integrated into one electronic control device in order to reduce the number of electronic control devices to be mounted, there are problems that a processing load of the electronic control device in which the functions are integrated is high and components are expensive. There are JP 2006-134203 A (PTL 1), JP 2010-262444 A (PTL 2), JP 2012-185541 A (PTL 3), JP 2018-67135 A (PTL 4), and JP 2020-29174 A (PTL 5) as technologies for curbing an increase in the processing load of an electronic control device.

PTL 1 (JP 2006-134203 A) discloses a distributed control system in which a plurality of control devices connected via a network execute a plurality of tasks in a distributed manner, in which each control device has a task management list started as a task to be executed by the control device itself, each task includes information on a deadline that is a time required until completion of execution or a period in which the task is started, and each control device determines whether or not all tasks in the task management list can satisfy the deadline or the task period, selects a task that can be executed by another control device satisfying the deadline or the task period from among the tasks included in the task management list, and requests another control device to execute the task in a case in which it is determined that not all the tasks can satisfy this.

PTL 2 (JP 2010-262444 A) discloses an in-vehicle device in which an OS having one or a plurality of tasks started with a startup period uniquely defined is mounted, the in-vehicle device including: an identification unit configured to identify a state of a host vehicle; and a startup period change unit configured to change the startup period for the task according to the state of the host vehicle identified by the identification unit.

PTL 3 (JP 2012-185541 A) describes an in-vehicle device that operates a plurality of tasks in parallel by sequentially giving execution rights to the tasks, the in-vehicle device including: a determination unit configured to determine a state of a host vehicle; and a change unit configured to change a frequency of operating each task according to the state of the host vehicle determined by the determination unit.

PTL 4 (JP 2018-67135 A) discloses a vehicle control device that controls an operation of a vehicle, the vehicle control device including: a storage unit that stores a task table that defines an arithmetic operation device that is to execute a control task for controlling the operation of the vehicle; first and second calculation devices that execute the control task according to the definition of the task table; and an update unit that updates the task table when the vehicle control device is activated or terminated.

PTL 5 (JP 2020-29174 A) discloses a vehicle control device including: an arithmetic operation load estimation unit configured to estimate an arithmetic operation load in real time on the basis of index data regarding an arithmetic operation load of a control task; and a task table updating unit configured to update a task table for controlling an operation of a vehicle on the basis of the calculation load.

### SUMMARY OF INVENTION

### Technical Problem

In the technologies described in PTL 1, PTL 4, and PTL 5, task tables assigned to a plurality of electronic control devices are updated to obtain task arrangement in which a function with a high priority does not stop in a case in which a processing load increases. However, change of task arrangement due to updating of these task tables does not consider the order of functions and the original roles of the electronic control devices such as recognition, perception, and control. In addition, in the technologies described in PTL 2 and PTL 3, a task execution period is changed to curb an increase in the processing load. According to curbing of an increase in the processing load due to a change in the task execution period, it is difficult to reduce the processing load to the extent of reducing the processing load of the electronic control unit in which functions are integrated because functions of an in-vehicle electronic control unit are limited in tasks whose execution period can be changed and the allowable execution period is limited.

An object of the present invention is to provide a technology for reducing a processing load of an electronic control device in which functions are integrated and reducing required performance of an entire in-vehicle system while considering an order of functions and an original role of each electronic control device.

### Solution to Problem

A representative example of the invention disclosed in the present application is as follows. That is, an electronic control device that executes arithmetic processing for controlling an operation of a vehicle includes: a determination unit that is connected to one or a plurality of electronic devices that recognize an external environment on the basis of information of a sensor provided in the vehicle, and determines an operation of the vehicle on the basis of external recognition information transmitted from the electronic devices; and a functional boundary change determination unit that determines changes in functions of the electronic control device and the electronic devices if it is determined that a processing load of the electronic control device is high.

### Advantageous Effects of Invention

According to one aspect of the present invention, a processing load at a peak of the electronic control device can be reduced. Problems, configurations, and effects other than those described above will be clarified by the following description of embodiments.

### BRIEF DESCRIPTION OF DRAWINGS

FIG. 1 is a functional block diagram of an automatic driving system to which an electronic control device load distribution system of embodiment 1 is applied.

FIG. 2 is a functional block diagram of the automatic driving system to which the electronic control device load distribution system of embodiment 1 is applied.

FIG. 3 is a flowchart of processing from external recognition to control command value output in embodiment 1.

FIG. 4 is a sequence diagram illustrating processing between an external recognition electronic device and an integrated electronic device according to embodiment 1.

FIG. 5 is a functional block diagram of an automatic driving system to which an electronic control device load distribution system of embodiment 3 is applied.

FIG. 6 is a flowchart of processing from external recognition to control command value output in embodiment 3.

FIG. 7 is a functional block diagram of an automatic driving system to which an electronic control device load distribution system of embodiment 4 is applied.

FIG. 8 is a flowchart of processing from external recognition to control command value output in embodiment 4.

FIG. 9 is a functional block diagram of an automatic driving system to which an electronic control device load distribution system of embodiment 6 is applied.

FIG. 10 is a flowchart of processing from external recognition to control command value output in embodiment 6.

FIG. 11 is a functional block diagram of an automatic driving system to which an electronic control device load distribution system of embodiment 7 is applied.

FIG. 12 is a functional block diagram of an automatic driving system to which an electronic control device load distribution system of embodiment 7 is applied.

FIG. 13 is a block diagram of an automatic driving system to which an electronic control device load distribution system of embodiment 8 is applied.

### DESCRIPTION OF EMBODIMENTS

Hereinafter, embodiments will be described with reference to the drawings.

### Embodiment 1

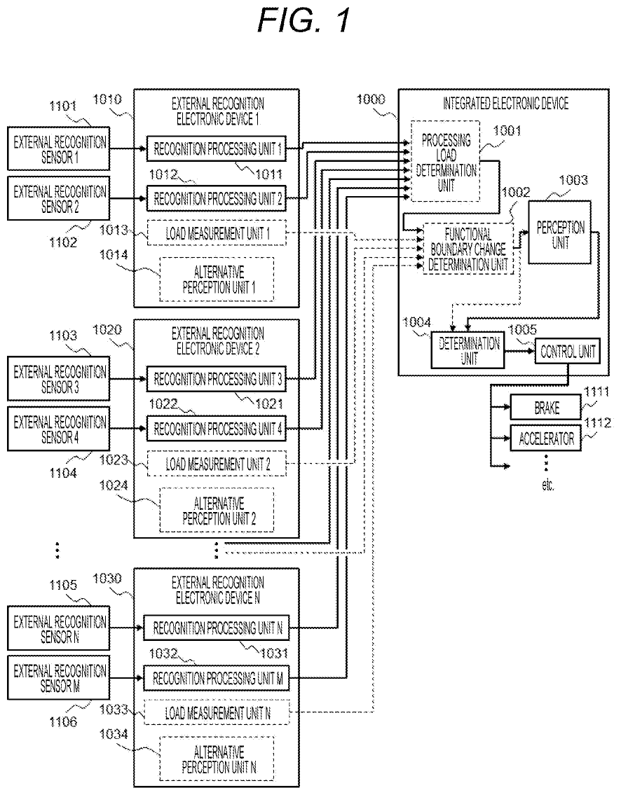

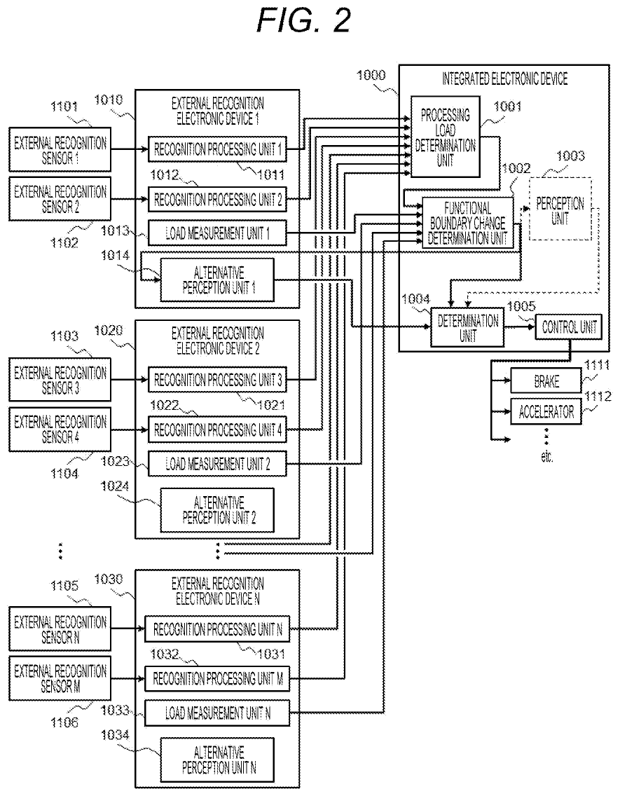

FIG. 1 and FIG. 2 are functional block diagrams of an automatic driving system to which an electronic control device load distribution system of embodiment 1 of the present invention is applied, FIG. 1 illustrates a normal operation state in which a processing load is low and a perception unit 1003 of an integrated electronic device 1000 operates, and FIG. 2 illustrates an operation state in which an alternative perception unit 1014 of an external recognition electronic device 1010 operates.

As illustrated in FIG. 1, in the automatic driving system, a plurality of external recognition sensors 1101 to 1106 is connected to a plurality of external recognition electronic devices 1010, 1020, and 1030, and the plurality of external recognition electronic devices 1010, 1020, and 1030 is connected to the single integrated electronic device 1000 in the normal operation state. In the external recognition electronic devices 1010, 1020, and 1030, recognition processing units 1011, 1012, 1021, 1022, 1031, and 1032 recognize target information such as a vehicle, a pedestrian, a sign, and a signal, and road markings such as a lane and a crosswalk, and output external recognition results on the basis of external information obtained from the connected external recognition sensor 1101 to 1106. In the integrated electronic device 1000, the perception unit 1003 integrates a plurality of input external recognition results, a determination unit 1004 determines a behavior of a vehicle on the basis of the integrated external recognition results, and a control unit 1005 converts the behavior of the vehicle into a control command value of an actuator of a brake 1111 or an accelerator 1112 and outputs the control command value. In such an automatic driving system, functions are integrated into the integrated electronic device 1000, and thus the integrated electronic device 1000 is required to have high arithmetic performance.

In the autonomous driving system of the present embodiment, as illustrated in FIG. 2, the integrated electronic device 1000 includes a processing load determination unit 1001 and a functional boundary change determination unit 1002, and the external recognition electronic devices 1010, 1020, and 1030 include load measurement units 1013, 1023, and 1033 and alternative perception units 1014, 1024, and 1034, respectively. The processing load determination unit 1001 determines whether or not the processing load of the integrated electronic device exceeds a preset threshold value. The functional boundary change determination unit 1002 determines an external recognition electronic device that will alternatively perform functions executed by the integrated electronic device 1000 according to the determination results of the processing load determination unit 1001 and the load status of each of the external recognition electronic devices 1010, 1020, and 1030. In addition, the load measurement units 1013, 1023, and 1033 measure or predict load values (for example, CPU use rate) of each of the external recognition electronic devices 1010, 1020, and 1030. The alternative perception units 1014, 1024, and 1034 execute recognition result integration processing in a case in which the functional boundary change determination unit 1002 instructs the external recognition electronic devices 1010, 1020, and 1030 to execute perception processing.

Note that, as illustrated in FIG. 2, the alternative perception unit 1014 may partially execute processing of the perception unit 1003 instead of all of the processing of the perception unit 1003. In addition, although the external recognition electronic devices 1010, 1020, and 1030 may alternatively perform processing of the integrated electronic device 1000, another electronic device other than the external recognition electronic devices may alternatively perform processing of the integrated electronic device 1000.

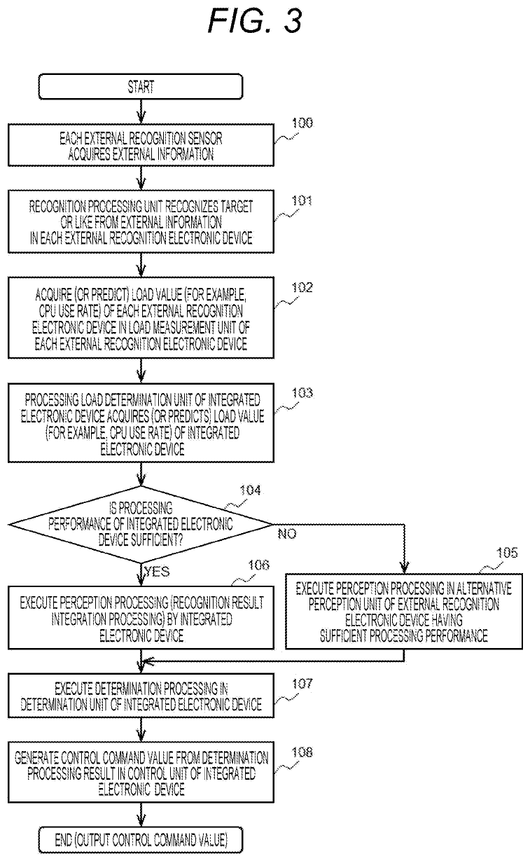

FIG. 3 is a flowchart of processing from external recognition to control command value output in the automatic driving system to which the electronic control device load distribution system of the present embodiment is applied.

Step 100: Each of the external recognition sensors 1101 to 1106 acquires external information. The external information is sensor information obtained by measuring the surroundings of a host vehicle by each of the external recognition sensors 1101 to 1106 and is, for example, image data if the external recognition sensors 1101 to 1106 include a camera and a set of points (three-dimensional point group) representing a three-dimensional position if the external recognition sensors 1101 to 1106 includes LiDAR.

Step 101: In each of the external recognition electronic devices 1010, 1020, and 1030, the recognition processing units 1011, 1012, 1021, 1022, 1031, and 1032 recognize a target, a lane, and the like around the host vehicle using external information.

Step 102: In each of the external recognition electronic devices 1010, 1020, and 1030, the load measurement units 1013, 1023, and 1033 acquire load values of the external recognition electronic devices 1010, 1020, and 1030 and transmit the acquired load values to the functional boundary change determination unit 1002. In the present embodiment, the load value is a CPU use rate. Although the CPU use rate is measured in the present embodiment, the CPU use rate may be predicted from external information. Further, the timing of acquiring the load values may be after step 103 which will be described later or during step 104 (timing at which processing performance of the integrated electronic device is found to be insufficient).

Step 103: The processing load determination unit 1001 in the integrated electronic device 1000 acquires a load value of the integrated electronic device 1000. In the present embodiment, the load value is a CPU use rate. Although the CPU use rate is measured in the present embodiment, the processing load may be predicted from external recognition results as illustrated in embodiment 2.

Step 104: The processing load determination unit 1001 determines whether or not the load value of the integrated electronic device 1000 exceeds a preset threshold value (that is, whether or not the processing performance of the integrated electronic device 1000 is sufficient), and the functional boundary change determination unit 1002 determines an external recognition electronic device that executes perception processing using the determination result of the processing load determination unit 1001 and the result of step 102 (load value of each of the external recognition electronic devices 1010, 1020, and 1030). Here, as to which external recognition electronic device is caused to execute the perception processing in a case in which the integrated electronic device 1000 has insufficient processing performance, for example, an external recognition electronic device having a small load value obtained in step 102 may be simply selected, or a rule for executing the processing in a distributed manner may be determined in advance.

Step 105: In a case in which the load value does not exceed the threshold value (that is, in a case in which the performance of the integrated electronic device 1000 is sufficient), the integrated electronic device 1000 executes the perception processing as illustrated in FIG. 1.

Step 106: In a case in which the load value exceeds the threshold value (that is, in a case in which the performance of the integrated electronic device 1000 is not sufficient), the functional boundary change determination unit 1002 selects an external recognition electronic device that alternatively performs the perception e function and requests that the selected external recognition electronic device will execute the perception processing. Then, as illustrated in FIG. 2, the perception unit 1003 of the integrated electronic device 1000 stops the function, and the alternative perception unit 1014 of the external recognition electronic device (for example, an external recognition electronic device having a low load and sufficient performance) determined by the functional boundary change determination unit 1002 executes the perception processing.

Step 107: The determination unit 1004 of the integrated electronic device 1000 executes determination processing using the result of the perception processing in step 105 or 106. Here, for switching of the input of the determination unit 1004, for example, even if perception results are always output from all of the perception unit 1003 and the alternative perception units 1014, 1024, and 1034, and an input including a valid value is adopted, an input from an electronic device that executes the perception processing from the functional boundary change determination unit 1002 may be adopted as illustrated in FIG. 2.

Step 108: The control unit 1005 of the integrated electronic device 1000 generates and outputs a control command value from the determination processing result (vehicle behavior information) of the determination unit 1004.

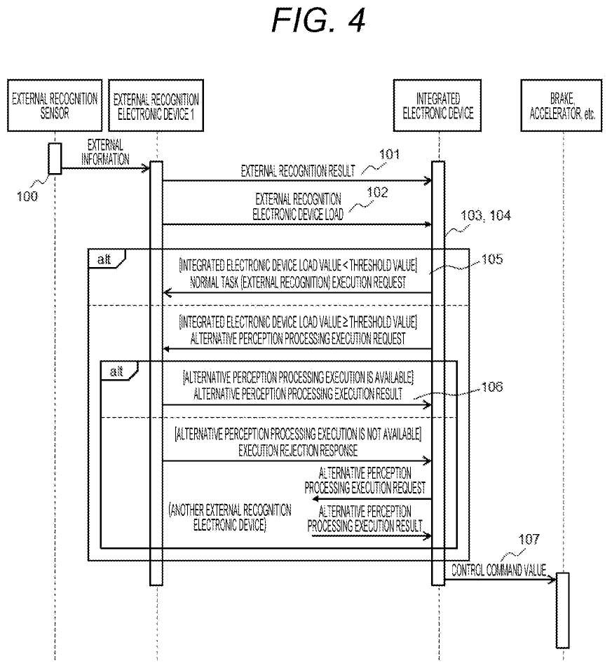

FIG. 4 is a sequence diagram illustrating processing between the external recognition electronic devices 1010, 1020, and 1030 and the integrated electronic device 1000 of the present embodiment. In FIG. 4, the same processing as that illustrated in FIG. 3 is denoted by the same reference numeral as that in FIG. 3. First, each of the external recognition electronic devices 1010, 1020, and 1030 receives external information from each of the external recognition sensors and recognizes a target, a lane, and the like around the host vehicle by the recognition processing unit (step 101).

Further, the external recognition electronic devices 1010, 1020, and 1030 transmit processing results of the recognition processing units 1011, 1012, 1021, 1022, 1031, and 1032 to the integrated electronic device 1000, calculate their current processing loads, and transmit calculation results to the integrated electronic device 1000 (step 102).

The processing load determination unit 1001 of the integrated electronic device 1000 calculates the load value of the integrated electronic device 1000 (steps 103 and 104), and, in a case in which the load value is equal to or less than a predetermined threshold value, notifies the external recognition electronic devices 1010, 1020, and 1030 of execution of a normal task, and the perception unit 1003 of the integrated electronic device 1000 executes perception processing (step 105).

In a case in which the load value exceeds the threshold value, the functional boundary change determination unit 1002 selects an external recognition electronic device that alternatively performs the perception function and requests that the selected external recognition electronic device will execute the perception processing, and the perception unit 1003 of the integrated electronic device 1000 stops the function.

In a case in which the external recognition electronic device that has received the alternative perception processing execution request cannot execute the perception processing, the external recognition electronic device transmits an execution rejection response to the integrated electronic device 1000. In a case in which the integrated electronic device 1000 has received the execution rejection response, the integrated electronic device 1000 reselects an external recognition electronic device that will execute the perception processing through the functional boundary change determination unit 1002, and requests that the selected external recognition electronic device will execute alternative perception processing.

In a case in which the external recognition electronic device that has received the alternative perception processing execution request can execute the perception processing, the external recognition electronic device executes the alternative perception processing and transmits a perception processing result to the integrated electronic device 1000 (step 106). The determination unit 1004 of the integrated electronic device 1000 executes determination processing on the basis of the result of step 105 or 106 (step 107), generates a control command value from the result of the determination processing, and outputs the control command value to an actuator such as the brake 1111 or the accelerator 1112 (step 108).

The functional boundary change determination unit 1002 may change the threshold value for determining the processing performance of the integrated electronic device 1000 depending on the driving state of the vehicle and the surrounding environment. The driving state of the vehicle is, for example, whether the vehicle is traveling on a general road, traveling on an expressway, automatically parking, or the like, and the surrounding environment is an intersection, presence or absence of a sidewalk, a road width, the number of lanes, presence or absence of a traffic light in a visible range, and the like.

### Embodiment 2

In embodiment 2 of the present invention, instead of directly measuring the load value of the integrated electronic device 1000 in step 100 of embodiment 1, the load value of the integrated electronic device 1000 is predicted from an external recognition result. In embodiment 2, the configuration of the automatic driving system is the same as that of embodiment 1, and thus the description thereof will be omitted. Further, processing of the automatic driving system is different from that of embodiment 1 with respect to the following points.

In step 102, loads of the external recognition electronic device are estimated from recognition results output from the external recognition electronic devices 1010, 1020, and 1030. For example, in recognition processing, the processing load increases as the number of recognition targets increases, and thus the loads of the external recognition electronic device can be estimated from the number of recognition targets included in external recognition results output from the external recognition electronic devices 1010, 1020, and 1030. Then, in step 105, an external recognition electronic device in which the number of targets included in the external recognition results transmitted from the external recognition electronic devices is equal to or less than a preset threshold value is selected as an external recognition electronic device that will execute perception processing.

### Embodiment 3

In embodiment 3 of the present invention, instead of directly measuring the load value of the integrated electronic device 1000 in step 100 of embodiment 1, the road type of a road on which the host vehicle is currently traveling is determined from map information and positioning information, and the functional boundary change determination unit 1002 changes function arrangement according to the road type. In embodiment 3, with respect to the configuration and processing of the automatic driving system, description of the same parts as those of embodiment 1 will be omitted and differences will be mainly described.

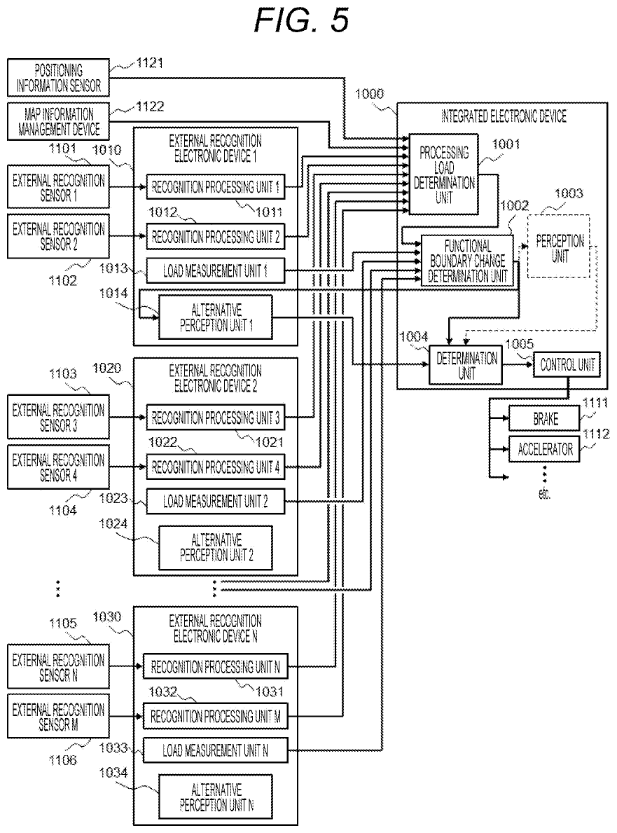

FIG. 5 is a functional block diagram of an automatic driving system to which an electronic control device load distribution system of the present embodiment is applied.

In embodiment 3, the processing load determination unit 1001 of the integrated electronic device 1000 determines the road type of a road on which the host vehicle is currently traveling using positioning information acquired from a positioning information sensor 1121 and map information acquired from a map information management device 1122. As the positioning information sensor 1121, a GNSS receiver that receives a signal from an artificial satellite and measures a position can be used. Since the number of targets to be perceived varies depending on the road type, the functional boundary change determination unit 1002 changes arrangement of perception processing. For example, since the number of targets to be recognized on a general road is greater than that on an expressway, the processing load of the integrated electronic device 1000 increases, and thus an external recognition electronic device alternatively performs a part of processing during traveling on the general road. In addition, since the number of targets to be recognized varies depending on a vehicle speed, the functional boundary change determination unit 1002 may change arrangement of the perception processing depending on the vehicle speed. In addition, since the number of targets to be recognized is small during acceleration and large during deceleration, the functional boundary change determination unit 1002 may change the arrangement of the perception processing depending on an acceleration.

Furthermore, the functional boundary change determination unit 1002 may change the arrangement of the perception processing depending on the driving state of the vehicle and the surrounding environment. For example, since the number of targets to be recognized changes depending on whether the vehicle is in automatic driving or in automatic parking, and the processing load of the integrated electronic device 1000 changes, the functional boundary change determination unit 1002 may change the arrangement of the perception processing. The driving state of the vehicle is whether the vehicle is in automatic driving or automatic parking, and the surrounding environment is an intersection, presence or absence of a sidewalk, a road width, the number of lanes, presence or absence of a traffic light in a visible range, and the like.

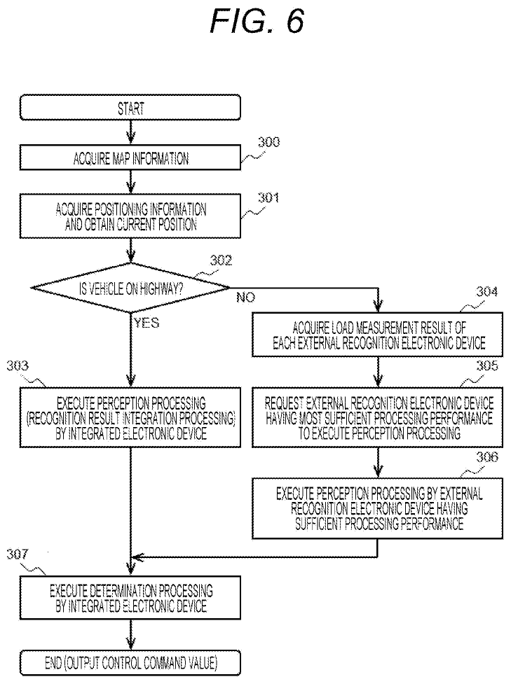

FIG. 6 is a flowchart of processing from external recognition to control command value output in the automatic driving system to which the electronic control device load distribution system of the present embodiment is applied.

Step 300: The processing load determination unit 1001 acquires map information from the map information management device 1122.

Step 301: The processing load determination unit 1001 acquires positioning information from the positioning information sensor 1121 and obtains a current position.

Step 302: The processing load determination unit 1001 determines whether or not the vehicle is on an expressway (that is, whether or not there are many targets necessary for performing automatic driving), and the functional boundary change determination unit 1002 determines an external recognition electronic device that will execute the perception processing using the determination result of the processing load determination unit 1001.

Step 303: In a case in which the vehicle is on an expressway (that is, in a case in which the number of targets to be perceived by the perception unit 1003 is small), the integrated electronic device 1000 performs the perception processing.

Step 304: In a case in which the vehicle is not on a freeway (that is, in a case in which the vehicle is on a general road having many targets to be perceived by the perception unit 1003), in each of the external recognition electronic devices 1010, 1020, and 1030, the load measurement units 1013, 1023, and 1033 acquire the load values of the external recognition electronic devices 1010, 1020, and 1030. In the present embodiment, the load value is a CPU use rate. Although the CPU use rate is measured in the present embodiment, the CPU use rate may be predicted from external information. Further, the timing of acquiring the load value may be before step 302.

Step 305: The functional boundary change determination unit 1002 selects an external recognition electronic device having most sufficient processing performance as an external recognition electronic device that will alternatively perform the perception function, and requests that the selected external recognition electronic device will execute the perception processing.

Step 306: Then, the perception unit 1003 of the integrated electronic device 1000 stops the function, and the alternative perception unit 1014 of the external recognition electronic device having sufficient processing performance determined by the functional boundary change determination unit 1002 executes the perception processing. Note that which external recognition electronic device is caused to execute the perception processing may be determined by a method of determining a rule for executing the processing in a distributed manner in advance.

Step 307: The determination unit 1004 of the integrated electronic device 1000 executes determination processing using the result of the perception processing in step 303 or 306. Here, for switching of the input of the determination unit 1004, example, for even if the perception result is always output from all of the perception unit 1003 and the alternative perception units 1014, 1024, and 1034, and an input including a valid value is adopted, an input from an electronic device that executes the perception processing from the functional boundary change determination unit 1002 may be adopted.

Then, the control unit 1005 of the integrated electronic device 1000 generates and outputs a control command value from the determination processing result (vehicle behavior information) of the determination unit 1004.

### Embodiment 4

In embodiment 4 of the present invention, instead of directly measuring the load values of the external recognition electronic devices 1010, 1020, and 1030 in step 103 of embodiment 1 and step 304 of embodiment 3, the load values of the external recognition electronic devices are predicted depending on a recognition result input to the integrated electronic device 1000. In embodiment 4, with respect to the configuration and processing of the automatic driving system, description of the same parts as those of embodiment 3 will be omitted and differences will be mainly described.

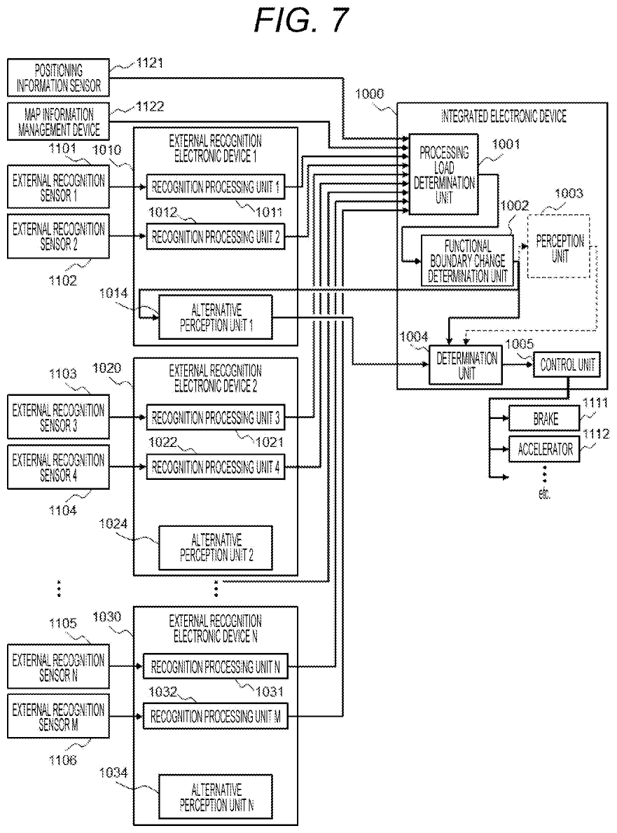

FIG. 7 is a functional block diagram of an automatic driving system to which the electronic control device load distribution system of the present embodiment is applied.

The external recognition electronic devices 1010, 1020, and 1030 of embodiment 4 do not include a load measurement unit, and the functional boundary change determination unit 1002 estimates loads of the external recognition electronic devices 1010, 1020, and 1030 and selects an external recognition electronic device that will alternatively perform the perception processing performed by the integrated electronic device 1000.

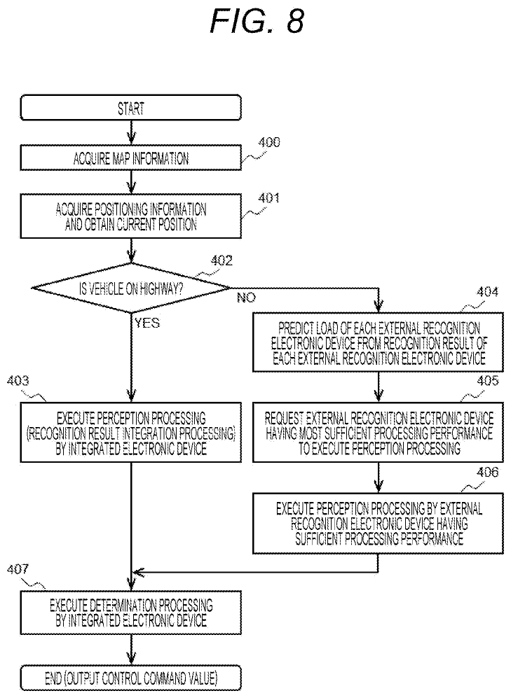

FIG. 8 is a flowchart of processing from external recognition to control command value output in the automatic driving system to which the electronic control device load distribution system of the present embodiment is applied.

The flowchart illustrated in FIG. 8 is different from the flowchart illustrated in FIG. 6 in step 404. That is, steps 400 to 403 and steps 405 to 407 are the same as steps 300 to 303 and steps 305 to 307 in FIG. 6.

Step 404: In a case in which the vehicle is not on an expressway (that is, in a case in which the vehicle is on a general load having many targets to be perceived by the perception unit 1003), the functional boundary change determination unit 1002 estimates the loads of the external recognition electronic devices: recognition results output from the external recognition electronic devices 1010, 1020, and 1030, and selects an external recognition electronic device that will alternatively perform the perception processing performed by the integrated electronic device 1000. For example, since the processing load increases as the number of recognition targets increases in recognition processing, the loads of the external recognition electronic devices can be estimated from the number of recognition targets included in the external recognition results output from the external recognition electronic devices 1010, 1020, and 1030. In the present embodiment, the load value is a CPU use rate. Further, the timing of acquiring the load value may be before step 302.

### Embodiment 5

In embodiment 5 of the present invention, when the functional boundary change determination unit 1002 selects an external recognition electronic device that will alternatively perform processing (step 103, step 304, and step 404), a part of processing of the external recognition electronic device is suspended or a processing period is changed in all the above-described embodiments. In addition, resources for exchanging a part of processing with the integrated electronic device 1000 are secured. In embodiment 5, the configuration of the automatic driving system is the same as those of embodiments 1 to 4, and thus the description thereof will be omitted. In addition, processing of the automatic driving system differs from those of embodiments 1 to 4 with respect to the following points.

For example, at a normal time, an execution period of the perception processing performed by the perception unit 1003 of the integrated electronic device 1000 and an execution period of the recognition processing performed by the recognition processing unit of each of the external recognition electronic devices 1010, 1020, and 1030 are set to be equal, and at the time of substituting the perception processing by the external recognition electronic device, an execution period of the recognition processing performed by the recognition processing unit of each of the external recognition electronic device that alternatively performs the perception processing of the integrated electronic device 1000 is set to be long to an integral multiple (integer is 2 or more) of the execution period of the perception processing performed by the perception unit 1003 of the integrated electronic device 1000, the processing loads of the external recognition electronic devices 1010, 1020, and 1030 are calculated, and an external recognition electronic device that will alternatively perform the perception processing is selected under the condition of securing resources for executing the perception processing.

Then, the recognition processing unit of the selected external recognition electronic device sets the execution period of the recognition processing to an integral multiple (integer is 2 or more) of the execution period of the perception processing performed by the perception unit 1003 to extend the execution period, thereby substituting the perception processing of the integrated electronic device 1000 with vacant resources.

### Embodiment 6

In embodiment 6 of the present invention, the external recognition electronic devices 1010, 1020, and 1030 include the processing load determination unit 1001 and the functional boundary change determination unit 1002. In embodiment 6, with respect to the configuration and processing of the automatic driving system, description of the same parts as those of embodiment 1 will be omitted and differences will be mainly described.

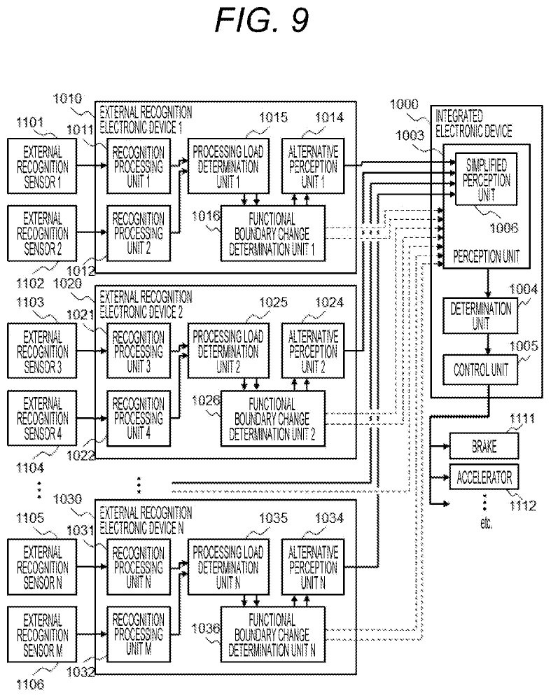

FIG. 9 is a functional block diagram of an automatic driving system to which the electronic control device load distribution system of the present embodiment is applied.

In embodiment 6, the plurality of external recognition electronic devices 1010, 1020, and 1030 are connected to the single integrated electronic device 1000.

In the external recognition electronic devices 1010, 1020, and 1030, recognition processing units 1011, 1012, 1021, 1022, 1031, and 1032 recognize target information such as a vehicle, a pedestrian, a sign, and a signal, and road markings such as a lane and a crosswalk, and output external recognition results on the basis of external information obtained connected external from the recognition sensor 1101 to 1106. Processing load determination units 1015, 1025, and 1035 determine whether the processing load of the integrated electronic device 1000 exceeds a preset threshold value. Functional boundary change determination units 1016, 1026, and 1036 determine an external recognition electronic device that will alternatively execute the function executed by the integrated electronic device 1000 according to the determination result of the processing load determination unit 1001 and a load status of each of the external recognition electronic devices 1010, 1020, and 1030. The alternative perception units 1014, 1024, and 1034 execute recognition result integration processing in a case in which the functional boundary change determination units 1016, 1026, and 1036 have determined execution of perception processing.

Since the load of perception processing of the integrated electronic device 1000 increases when the number of recognition targets input to the integrated electronic device 1000 increases, in each of the external recognition electronic devices 1010, 1020, and 1030, instead of outputting a recognition target according to external information from each of the external recognition sensors 1101 to 1106, recognition targets according to external information from the connected external recognition sensors 1101 to 1106 are integrated and output, and thus the number of recognition targets received by the integrated electronic device 1000 can be decreased and the load of the perception processing can be reduced.

In the integrated electronic device 1000, the perception unit 1003 integrates a plurality of input external recognition results, a determination unit 1004 determines a behavior of a vehicle on the basis of the integrated external recognition results, and a control unit 1005 converts the behavior of the vehicle into a control command value of an actuator of a brake 1111 or an accelerator 1112 and outputs the control command value. The integrated electronic device 1000 includes a simplified perception unit 1006 in the perception unit 1003. The simplified perception unit 1006 executes perception processing on the basis of input external recognition results or perception processing results at the time of operation of the alternative perception unit 1014, 1024, or 1034 of any of the external recognition electronic devices 1010, 1020, and 1030.

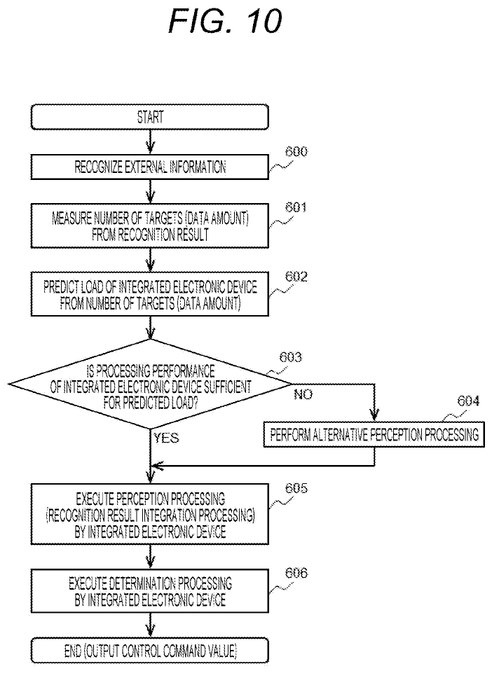

FIG. 10 is a flowchart of processing from external recognition to control command value output in the automatic driving system to which the electronic control device load distribution system of the present embodiment is applied.

Step 600: The recognition processing units 1011, 1012, 1021, 1022, 1031, and 1032 recognize external information obtained from the external recognition sensors 1101 to 1106.

Step 601: The processing load determination units 1015, 1025, and 1035 measure the number of targets from recognition results of the external information from the recognition processing units 1011, 1012, 1021, 1022, 1031, and 1032.

Step 602: The processing load determination units 1015, 1025, and 1035 predict the processing load of the integrated electronic device 1000 from the measured number of targets.

Step 603: The processing load determination units 1015, 1025, and 1035 determine whether or not the processing load exceeds a preset threshold value (whether or not the performance of the integrated electronic device 1000 is sufficient).

Step 604: In a case in which the processing load determination units 1015, 1025, and 1035 determine that the processing load exceeds the threshold value, the functional boundary change determination units 1016, 1026, and 1036 select an external recognition electronic device that will alternatively execute the perception processing executed by the integrated electronic device 1000, and the selected external recognition electronic device executes the perception processing. At this time, similarly to embodiment 5, the functional boundary change determination units 1016, 1026, and 1036 may secure processing resources of the external recognition electronic device by suspending some functions of the external recognition electronic device or changing a processing period.

Step 605: The perception unit 1003 or the simplified perception unit 1006 of the integrated electronic device 1000 executes the perception processing on the basis of input external recognition results or perception processing results.

Step 606: The determination unit 1004 of the integrated electronic device 1000 executes determination processing using the result of the perception processing in step 605. Thereafter, the control unit 1005 generates and outputs a control command value from the determination processing result (vehicle behavior information) of the determination unit 1004.

### Embodiment 7

In embodiment 7 of the present invention, in a case in which the processing load of the integrated electronic device 1000 increases, the external recognition electronic devices are caused to alternatively perform the function of the determination unit 1004. In embodiment 7, with respect to the configuration and processing of the automatic driving system, description of the same parts as those of embodiment 1 will be omitted and differences will be mainly described.

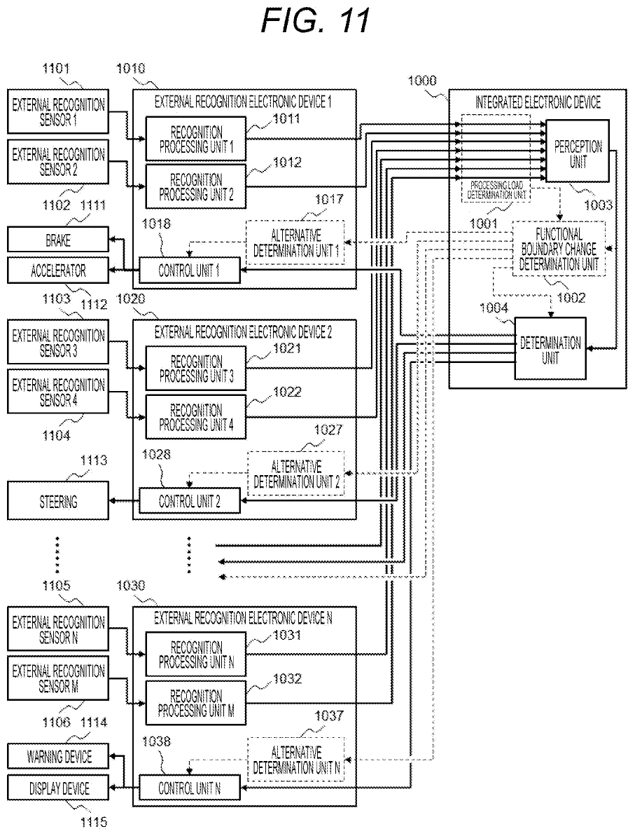

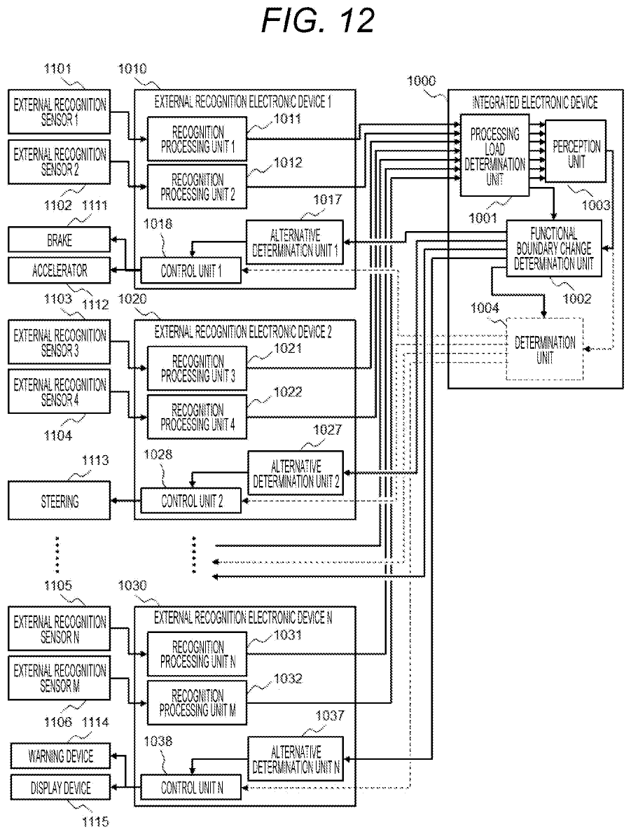

FIG. 11 and FIG. 12 are functional block diagrams of an automatic driving system to which the electronic control device load distribution system of the present embodiment is applied, FIG. 11 illustrates a normal operation state in which the determination unit 1004 of the integrated electronic device 1000 operates with a low processing load, and FIG. 12 illustrates an operation state in which alternative determination units 1017, 1027, and 1037 of the external recognition electronic devices 1010, 1020, and 1030 operate.

As illustrated in FIG. 11, in the normal operation state, the plurality of external recognition sensors 1101 to 1106 is connected to the plurality of external recognition electronic devices 1010, 1020, and 1030, and the plurality of external recognition electronic devices 1010, 1020, and 1030 is connected to the single integrated electronic device 1000 in the automatic driving system. In the external recognition electronic devices 1010, 1020, and 1030, recognition processing units 1011, 1012, 1021, 1022, 1031, and 1032 recognize target information such as a vehicle, a pedestrian, a sign, and a signal, and road markings such as a lane and a crosswalk, and output external recognition results on the basis of external information obtained from the connected external recognition sensor 1101 to 1106. In the integrated electronic device 1000, the perception unit 1003 integrates a plurality of input external recognition results, and the determination unit 1004 determines a behavior of the vehicle on the basis of the integrated external recognition result and sends the behavior to the external recognition electronic devices 1010, 1020, and 1030. In the external recognition electronic devices 1010, 1020, and 1030, the control units 1018, 1028, and 1038 convert the behavior of the vehicle into control command values of actuators of the brake 1111, the accelerator 1112, and a steering 1113, and operation commands of a warning device 1114 and a display device 1115, and output the control command values and the operation commands. In such an automatic driving system, the functions of the determination unit 1004 can be divided into a function related to acceleration/deceleration of the vehicle, a function related to steering of the vehicle, and a warning and display function for a driver in accordance with function sharing of the control units 1018, 1028, and 1038.

In the automatic driving system of the present embodiment, as illustrated in FIG. 12, the integrated electronic device 1000 includes the processing load determination unit 1001 and the functional boundary change determination unit 1002, and the external recognition electronic devices 1010, 1020, and 1030 respectively include alternative determination units 1017, 1027, and 1037. The processing load determination unit 1001 determines whether or not the processing load of the integrated electronic device 1000 exceeds a preset threshold value. In addition, the processing load determination unit 1001 estimates the processing load of each of the external recognition electronic devices 1010, 1020, and 1030 from recognition results output from the integrated electronic device 1000. The functional boundary change determination unit 1002 determines an external recognition electronic device that will alternatively execute the function of the determination unit 1004 executed in the integrated electronic device 1000 according to the processing load of the integrated electronic device 1000 and the load status of each of the external recognition electronic devices 1010, 1020, and 1030. The alternative determination units 1017, 1027, and 1037 execute determination processing in a case in which the functional boundary change determination unit 1002 instructs the external recognition electronic devices 1010, 1020, and 1030 to execute determination processing. That is, when the processing load of the integrated electronic device 1000 increases, the alternative determination unit 1017 of the external recognition electronic device 1010 executes a determination function related to acceleration/deceleration instead of perception processing, the alternative determination unit 1027 of the external recognition electronic device 1020 executes a determination function related to steering, and the alternative determination unit 1037 of the external recognition electronic device 1030 executes a warning and display function for a driver, whereby the processing load of the integrated electronic device 1000 can be reduced. Substitution of the functions by the alternative determination units 1017, 1027, and 1037 may be performed by substituting all the functions of the determination unit 1004 or substituting some of the functions of the determination unit 1004 as illustrated in FIG. 12.

### Embodiment 8

In embodiment 8 of the present invention, the plurality of external recognition electronic devices 1010, 1020, and 1030 are connected to each other. In embodiment 8, with respect to the configuration and processing of the automatic driving system, description of the same parts as those of the above-described embodiments will be omitted and differences will be mainly described.

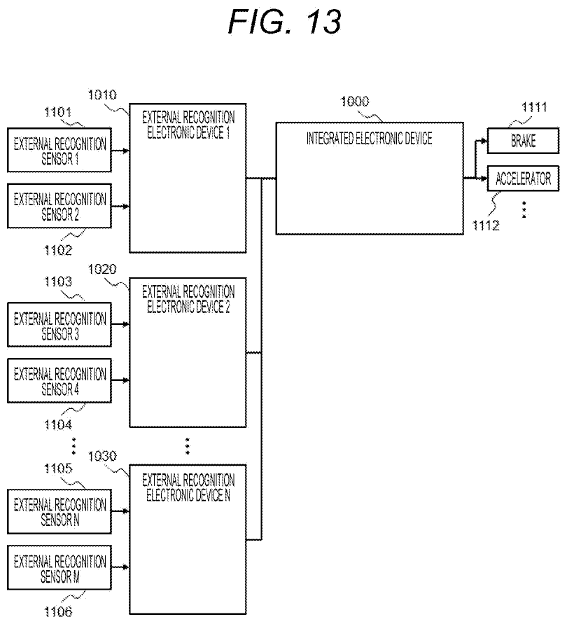

FIG. 13 is a block diagram of an automatic driving system to which the electronic control device load distribution system of the present embodiment is applied, and illustrates connection of electronic devices constituting the automatic driving system. In the present embodiment, the plurality of external recognition electronic devices described above is connected to each other. In the present embodiment, at least one of the processing load determination unit 1001 or the functional boundary change determination unit 1002 may be disposed in at least one of the external recognition electronic devices 1010, 1020, and 1030.

### Embodiment 9

In embodiment 9 of the present invention, in a case in which the processing load of any of the external recognition electronic devices has increased in the connection form of embodiment 8, another external recognition electronic device alternatively performs processing. In embodiment 9, with respect to the configuration and processing of the automatic driving system, description of the same parts as those of the above-described embodiments will be omitted and differences will be mainly described.

In the present embodiment, the external recognition electronic devices do not alternatively process the processing load of the integrated electronic device 1000, and in a case in which the processing load of the external recognition electronic device has increased, another external recognition electronic device alternatively performs processing. For example, in a case in which four external recognition electronic devices for a front recognition sensor, a right side recognition sensor, a left side recognition sensor, and a rear recognition sensor are mounted on a vehicle, the number of targets may be large in the front and small in the rear. In such a case, the external recognition electronic device for the rear recognition sensor may alternatively perform a part of recognition processing of the external recognition electronic device for the front recognition sensor.

### Embodiment 10

In embodiment 10 of the present invention, a plurality of integrated electronic devices 1000 is provided. Substitution of processing may be performed between the plurality of integrated electronic devices 1000.

### Embodiment 11

In embodiment 11 of the invention, a future load is predicted. For example, the processing load determination unit 1001 predicts a future load value from a current load value (a CPU usage rate, the number of recognition targets, or the like). In the four external recognition electronic devices described above in embodiment 9, in a case in which the vehicle is moving forward, after the number of recognition targets of the external recognition electronic device for the front recognition sensor increases, an increase in the number of recognition targets of the external recognition electronic device for the right side recognition sensor or the external recognition electronic device for the left side recognition sensor can be predicted.

### Embodiment 12

In embodiment 12 of the present invention, past travel data is trained to predict a future load. For example, a CPU use rate that varies with time may be extrapolated to predict future invisibility. In addition, in the processing load determination unit 1001 of embodiment 11, the future number of recognition targets can be predicted from a change in the current number of recognition targets from several seconds ago by using a DNN trained using changes in the number of recognition targets in past travel data as teacher data. Then, the processing load of each electronic device can be predicted using the predicted number of recognition targets.

Although the external recognition electronic devices 1010, 1020, and 1030 alternatively perform processing of the integrated electronic device 1000, or the external recognition electronic devices 1010, 1020, and 1030 alternatively perform processing each other in the above-described embodiments, the present invention can be applied to any electronic control device as long as another electronic control device alternatively performs processing of another electronic control device.

As described above, according to the integrated electronic device 1000 of the embodiments of the present invention, the processing load at a peak time can be reduced, and performance required for the integrated electronic device 1000 can be reduced. In addition, since processing of the integrated electronic device 1000 is alternatively performed using resources of other existing electronic devices, it is possible to reduce the processing load at a peak time of the integrated electronic device 1000 without separately providing an electronic device.

Note that the present invention is not limited to the above-described embodiments, and includes various modifications and equivalent configurations within the spirit of the appended claims. For example, the above-described embodiments have been described in detail for easy understanding of the present invention, and the present invention is not necessarily limited to those having all the described configurations. Further, a part of the configuration of a certain embodiment may be replaced with the configuration of another embodiment. In addition, the configuration of another embodiment may be added to the configuration of a certain embodiment. In addition, with respect to a part of the configuration of each embodiment, addition, deletion, or substitution of another configuration may be made.

In addition, some or all of the above-described configurations, functions, processing units, processing means, and the like may be realized by hardware by, for example, designing with an integrated circuit, or may be realized by software by a processor interpreting and executing a program for realizing each function.

Information such as a program, a table, and a file for realizing each function can be stored in a storage device such as a memory, a hard disk, and a solid state drive (SSD), or a recording medium such as an IC card, an SD card, and a DVD.

In addition, control lines and information lines that are considered to be necessary for description are illustrated, and not all control lines and information lines necessary for implementation are illustrated. In practice, it may be considered that almost all components are connected to each other.

1. An electronic control device that executes arithmetic processing for controlling an operation of a vehicle, comprising:
a determination unit that is connected to one or a plurality of electronic devices that recognize an external environment on the basis of information of a sensor provided in the vehicle and determines an operation of the vehicle on the basis of external recognition information transmitted from the electronic devices; and
a functional boundary change determination unit that determines changes in functions of the electronic control device and the electronic device if it is determined that a processing load of the electronic control device is high.

2. The electronic control device according to claim 1, wherein, upon determining that the functions of the electronic control device and the electronic devices have changed, the functional boundary change determination unit instructs the electronic device to change at least one of the functions and a task period.

3. The electronic control device according to claim 1, wherein the functional boundary change determination unit determines a processing load of the electronic control device on the basis of a traveling status of a host vehicle determined on the basis of map information and positioning information.

4. The electronic control device according to claim 1, wherein the functional boundary change determination unit determines the processing load of the electronic control device on the basis of at least one of the number of external targets acquired by the sensor, a speed of the host vehicle, and an acceleration of the host vehicle.

5. The electronic control device according to claim 1, wherein the functional boundary change determination unit determines the processing load of the electronic control device on the basis of a temporal change in the processing load of the electronic control device.

6. The electronic control device according to claim 1, wherein the functional boundary change determination unit sets an execution period of processing performed by the electronic device to an integral multiple of an execution period of processing performed by the electronic control device, and causes the electronic device to execute a function of the electronic control device.

7. The electronic control device according to claim 1, wherein the functional boundary change determination unit suspends a part of processing performed by the electronic device and causes the electronic device to execute the function of the electronic control device.

8. The electronic control device according to claim 1, wherein the electronic device executes processing of the electronic control device disposed in the electronic device according to a change in the functions.

9. The electronic control device according to claim 8, wherein the functional boundary change determination unit causes an electronic device with a low current processing load to execute a part of processing of the electronic control device.

10. The electronic control device according to claim 1, comprising a first processing load determination unit that determines the processing load of the electronic control device.

11. An in-vehicle system comprising:
the electronic control device according to claim 1; and
one or a plurality of the electronic devices.

12. The in-vehicle system according to claim 11, wherein the electronic device includes a second processing load determination unit that determines a processing load of the electronic control device.

13. The in-vehicle system according to claim 12, wherein the second processing load determination unit determines a load of the electronic control device based on external recognition information transmitted to the electronic control device.

14. The in-vehicle system according to claim 13, wherein the second processing load determination unit determines the load of the electronic control device based on the number of targets included in external recognition information transmitted to the electronic control device.
